(19) United States
(12) Patent Application Publication
(10) Pub. No.: US 2012/0145453 A1
(43) Pub. Date: Jun. 14, 2012

(54) POWER CABLE WITH MICRODUCT

(75) Inventors: William S. TEMPLE, Loveland, OH (US); Edward E. WALCOTT, Crittenden, KY (US); Jacob HANEY, Cincinnati, OH (US); James FREESTONE, Danville, IN (US); Gordon BAKER, Milford, OH (US)

(73) Assignee: GENERAL CABLE TECHNOLOGIES CORPORATION, Highland Heights, KY (US)

(21) Appl. No.: 12/967,107

(22) Filed: Dec. 14, 2010

(51) Int. Cl. H02G 3/02; H01B 13/14

(52) U.S. Cl. 174/70 C; 156/51

(57) ABSTRACT

The present invention provides a power cable that comprises a cable core that has at least one power conductor. The cable core defines a longitudinal axis of the cable. A jacket surrounds the cable core and the jacket has an outer surface. A longitudinal duct is coupled to the outer surface of the jacket and extends substantially parallel to the longitudinal axis of the cable core. The longitudinal duct is hollow to receive at least one optical fiber.

### FIELD OF THE INVENTION

The present invention generally relates to a power cable having microduct incorporated therewith for accommodating optical fiber cables. More specifically, a hollow microduct is installed longitudinally adjacent to the cable jacket of the cable or down the center axis of a multiple conductor cable assembly.

### BACKGROUND OF THE INVENTION

The conventional method for distributed temperature sensing (DTS) in electrical circuits is to use optical fiber cable to function as a linear sensor. Once optical fiber is installed alongside of an electrical power cable circuit, the optical fibers generate a continuous temperature profile along the length of the electrical circuit providing real time temperature data to safely maximize the distribution capability. This method also provides detection of “hot spots” and identifies potential weak areas of an installed power cable system. These hot spots can then be proactively addressed to prevent damage and premature aging of electrical power cable systems.

Currently, however, there is no easy way to install such optical fiber cables for the purpose of DTS on distribution cables. Because of the fragile nature of optical fiber cables, the fibers often get damaged using conventional installation methods. That is because a utility is required to pull in the fiber cables after the power cable installation. Therefore, a need exists for providing DTS optical fiber cable either during or after power cable installation without causing damage to the optical fiber cables.

### SUMMARY OF THE INVENTION

Accordingly, the present invention provides a power cable that comprises a cable core that has at least one power conductor. The cable core defines a longitudinal axis of the cable. A jacket surrounds the cable core and the jacket has an outer surface. A longitudinal duct may be coupled to the outer surface of the jacket and extend substantially parallel to the longitudinal axis of the cable core. The longitudinal duct may be hollow to receive at least one optical fiber.

The present invention also provides a power cable that comprises a cable core that has at least one power conductor. The cable core defines a longitudinal axis of the cable. A jacket surrounds the cable core. A longitudinal duct may be co-extruded with the jacket such that the duct is substantially parallel to the longitudinal axis of the cable core. A web extends between the jacket and the duct, wherein the longitudinal duct may be configured to receive optical fiber.

The present invention further provides a power cable that comprises a cable core that has at least one power conductor. The cable core defines a longitudinal axis of the cable. A jacket surrounds the cable core. The jacket has an outer surface that defines an outer diameter of the jacket. A longitudinal duct is coupled to the outer surface of the jacket such that the duct is substantially parallel to the longitudinal axis of cable core. The longitudinal duct has an outer diameter. The outer diameter of the duct may be substantially smaller than the outer diameter of the jacket, wherein the longitudinal duct may be hollow to receive optical fiber.

The present invention also provides a power cable assembly that comprises a plurality of cables. At least one cable of the plurality of cables includes a cable core that has at least one power conductor and defines a longitudinal axis of the cable. A jacket surrounds the cable core and has an outer surface. A longitudinal duct may be coupled to the outer surface of the jacket and extend substantially parallel to the longitudinal axis of the cable core. The longitudinal duct may be hollow to receive at least one optical fiber.

The present invention yet further provides a power cable assembly that comprises at least a first cable having a cable core with at least one power conductor, and a first jacket that surrounds the cable core, and at least a second cable that has a cable core with at least one power conductor, and a second jacket that surrounds the cable core of the second cable. The first and second cables may be arranged to form a longitudinal receiving area therebetween. A longitudinal duct may be received in the longitudinal receiving area.

The present invention also provides a method for making a power cable that comprises the steps of extruding a power cable that has a cable core with at least one power conductor and a jacket that surrounds the cable core; and co-extruding a hollow longitudinal duct with the extrusion of the power cable such that the longitudinal duct is coupled to an outer surface of the jacket and a outer diameter of the longitudinal duct is substantially smaller than an outer diameter of the jacket of the power cable.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a cross-sectional view of a power cable according to a first exemplary embodiment of the present invention, showing a microduct coupled thereto by a web;

FIG. 1B is a cross-sectional view of a power cable assembly having at least one power cable according to the first exemplary embodiment illustrated in FIG. 1A;

FIG. 2A is a cross-sectional view of a power cable according to a second exemplary embodiment of the present invention, showing a microduct embedded in an outer surface of the cable;

FIG. 2B is a cross-sectional view of a power cable assembly having at least one power cable according to the second exemplary embodiment illustrated in FIG. 2A;

FIG. 3A is a cross-sectional view of a power cable according to a third exemplary embodiment of the present invention, showing a microduct embedded in an outer surface of the cable;

FIG. 3B is a cross-sectional view of a power cable assembly having at least one power cable according to the third exemplary embodiment illustrated in FIG. 3A;

FIG. 4A is a cross-sectional view of a power cable according to a fourth exemplary embodiment of the present invention, showing a microduct coupled thereto by a channel;

FIG. 4B is a cross-sectional view of a power cable assembly having at least one power cable according to the fourth exemplary embodiment illustrated in FIG. 4A;

FIG. 5 is a cross-sectional view of a power cable assembly according to a fifth exemplary embodiment of the present invention, showing a microduct extending through the center of the cable assembly;

FIG. 6 is a cross-sectional view of a power cable assembly according to a sixth exemplary embodiment of the present invention, showing a microduct extending through the center of the cable assembly; and

FIG. 7 is a cross-sectional view of a power cable assembly according to a seventh exemplary embodiment of the present invention, showing a microduct extending through the center of the cable assembly.

### DETAILED DESCRIPTION OF THE INVENTION

Referring to the figures, the present invention generally provides a microduct incorporated with a power cable or a power cable assembly that is designed to allow optical fiber cabling to be installed either during or after the power cable installation. For example, the optical fiber may be blown into the hollow microduct either during or after the power cable is installed, thereby avoiding damage to the optical fiber. Utilizing a power cable or a multiple power cable assembly with a microduct, as taught by the present invention, allows conventional power cable installation and accessory (splicing and terminating) methods and processes to be employed while providing DTS to the power cabling.

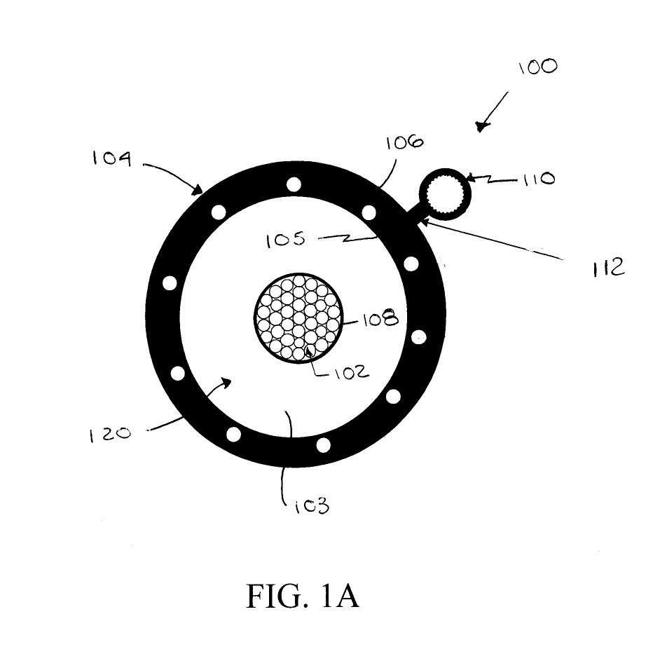

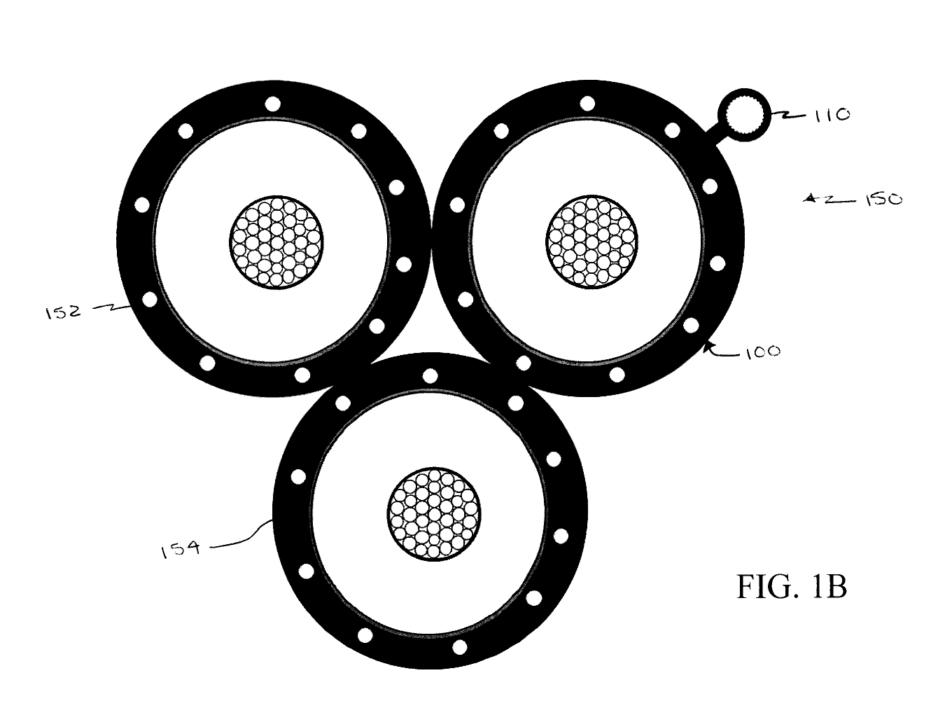

FIG. 1A illustrates a first exemplary embodiment of a power cable 100 of the present invention. The power cable 100 includes an insulated cable core 120 and a jacket 104 surrounding the cable core. The cable core 120 consists of a stranded or solid metal conductor 102 surrounded by an insulation system which may include a semi-conducting conductor shield layer 108, an insulation layer 103, and a semi-conducting insulation shield layer 105. The cable core 120 may optionally include a metallic shield surrounding the insulation system. The metal conductor 102 may be formed from copper or aluminum, for example.

A microduct 110 extends adjacent the jacket 104 and may be coupled to the outer surface 106 thereof by a web 112. The microduct 110 is preferably co-extruded with the cable jacket 104 such that the microduct 110 is encapsulated in the same compound as the cable jacket and is held in place by the web 112. The web 112 is a small amount of compound joining the power cable jacket 104 and the microduct 110. The microduct 110 extends longitudinally along the length of the cable 100. The co-extruded jacket 104 and microduct 110 may be made of a thermoplastic or a thermoset polymeric material, for example, such as a thermoset crosslinked polyethylene, a thermoplastic linear low density polyethylene, a thermoplastic polypropylene, or the like. The jacket 104 and microduct 110 may be either semi-conductive or non-conductive. Alternatively, the microduct 110 may be formed separately from the cable 100 and subsequently attached to the outer surface 106 of the jacket 104.

The microduct 110 is preferably substantially smaller than the power cable 100. For example, the outer diameter of the cable jacket 104 may be about 2 inches where the outer diameter of the microduct is significantly less at about 10 mm. The inner diameter of the microduct 110 may be about 2-12 mm.

As seen in FIG. 1B, the power cable 100 may be incorporated into a power cable assembly 150. The cable assembly includes a plurality of powers cables that may be twisted together. At least one of the plurality of cables is the power cable 100 having the microduct 110. The remaining cables 152 and 154, as illustrated in FIG. 1B, do not include a microduct. Alternatively, one or more of the remaining cables 152 and 154 may include a microduct similar to the microduct 110. Although FIG. 1B shows three cables, any number of cables may be included in the power cable assembly 150.

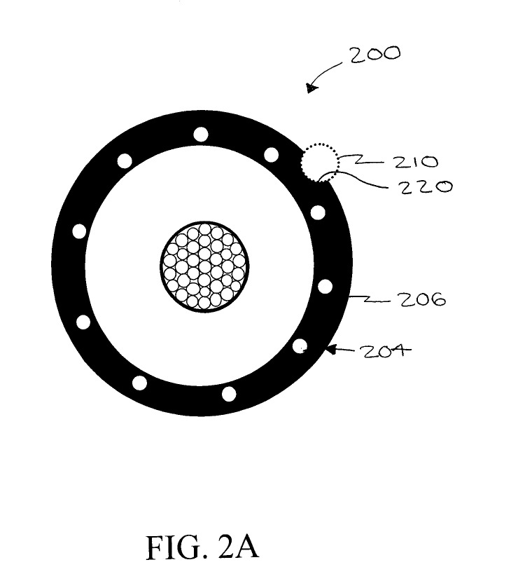

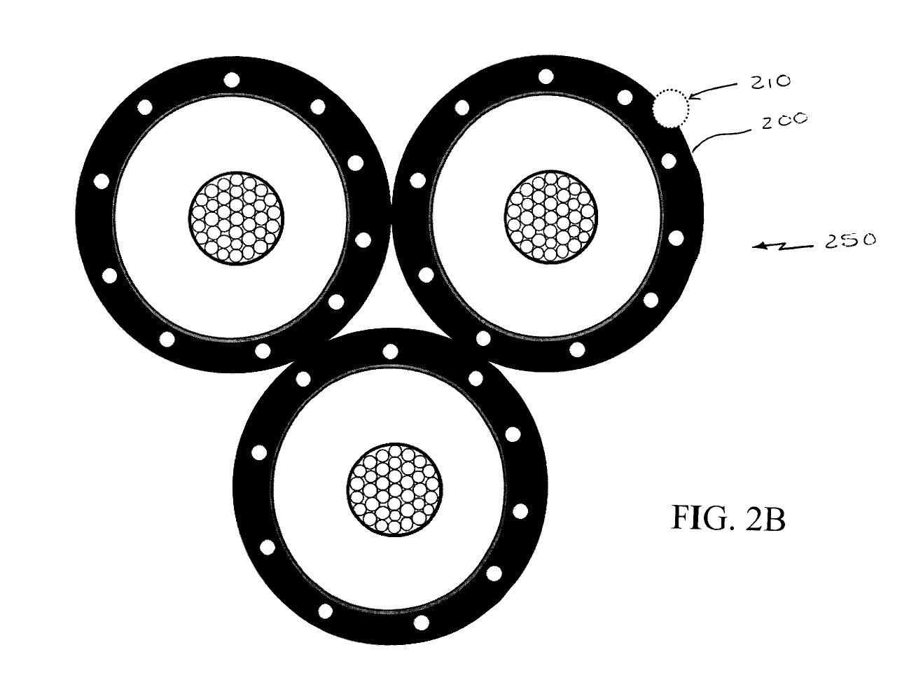

FIG. 2A illustrates a second exemplary embodiment of a power cable 200 according to the present invention. The power cable 200 is similar to the power cable 100 of the first embodiment, except that the microduct 210 is partially embedded in the outer surface 206 of the cable jacket 204. More specifically, a longitudinal recess 220 is formed in the jacket's outer surface 204 that is sized to receive at least a portion of the microduct 210. The microduct 210 is preferably held in place in the recess 220 with an adhesive, such as a double-sided tape, a hot melt adhesive, glue or the like. Alternatively, the recess 220 can be eliminated and the microduct 210 bonded to the outer surface 206 of the cable jacket 204.

Similar to the first embodiment, the power cable 200 may be incorporated into a power cable assembly 250, as seen in FIG. 2B. The power cable assembly 250 includes a plurality of cables where at least one of the cables is the power cable 200 having the microduct 210. As with power cable assembly 150, the assembly 250 may include multiple cables having a microduct like microduct 210 of the power cable 200. And the power cable assembly 250 may include any number of power cables.

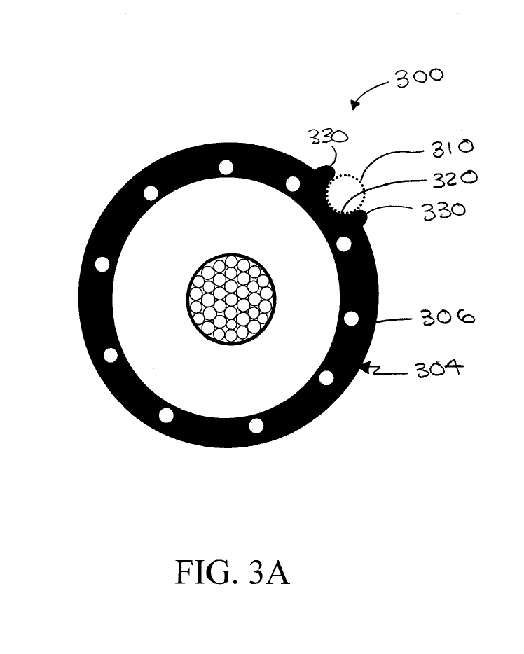

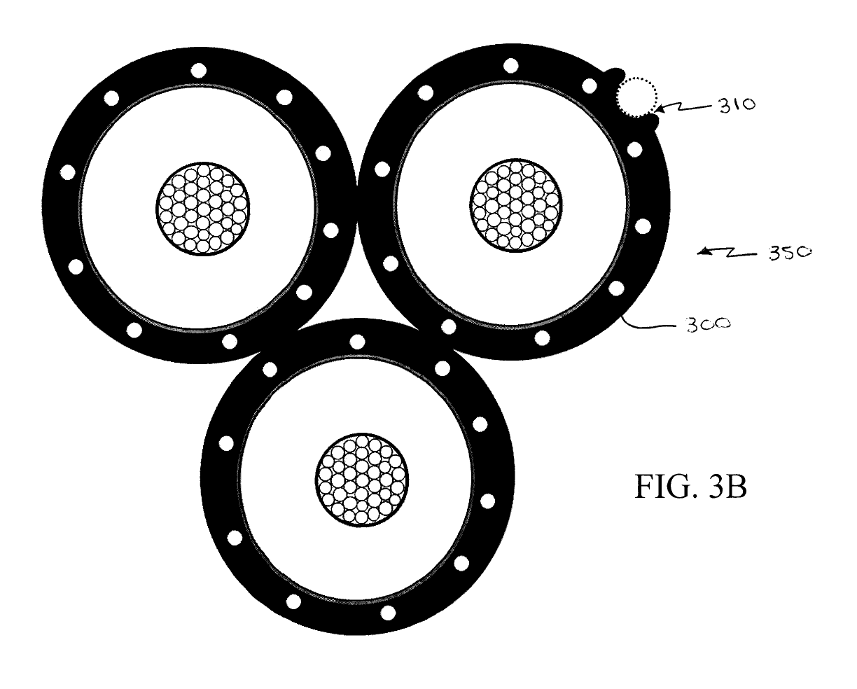

FIG. 3A illustrates a third exemplary embodiment of a power cable 300 according to the present invention. The power cable 300 adds longitudinal ribs 330 to the longitudinal recess of the power cable 200 of the second embodiment to provide additional support to the microduct 310. The support of the ribs 330 helps to keep the microduct 310 in place and to provide protection to the microduct, such as crush resistance. In particular, the ribs 330 may extend along the outer surface 306 of the jacket 304 on either side of the longitudinal recess 320. The ribs 330 preferably extend from the jacket's outer surface 306 such that the ribs 330 extend about 75% of the outer diameter of the microduct 310, as seen in FIG. 3A. Alternatively, the ribs 330 may be taller than the microduct 310 such that the ribs 330 extend past the outer diameter of the microduct 310. The ribs 330 may also be shorter, that is less than 75% of the outer diameter of the microduct 310. Like in the second embodiment, the microduct 310 may be held in place in the recess 320 with an adhesive. The ribs 330 are preferably integrally with the cable's jacket 304; however, the ribs 330 may be formed separately and attached to the jacket's outer surface 306.

The power cable 300 may also be incorporated into a power cable assembly 350, as seen in FIG. 3B. Like the power cable assemblies 150 and 250, the power cable assembly 350 includes a plurality of cables where at least one of the cables is the power cable 300 having the microduct 310. The power cable assembly 350 may include multiple cables having a microduct like microduct 310 of the power cable 300. And the power cable assembly 350 may include any number of power cables.

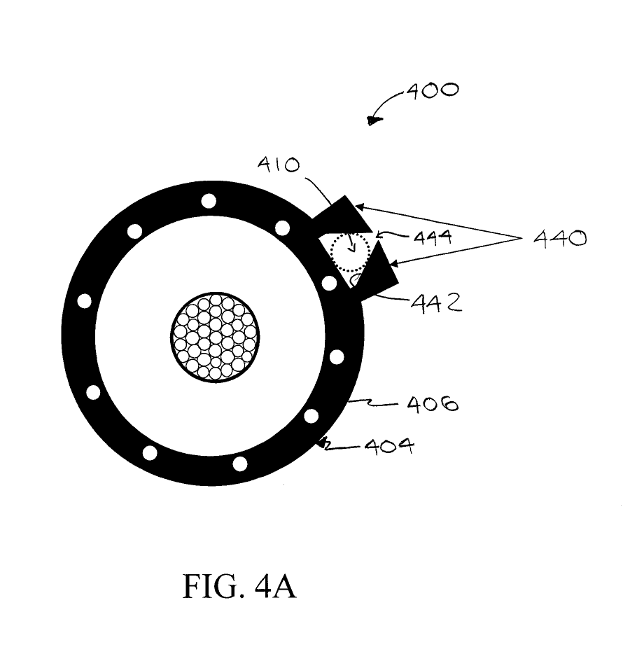

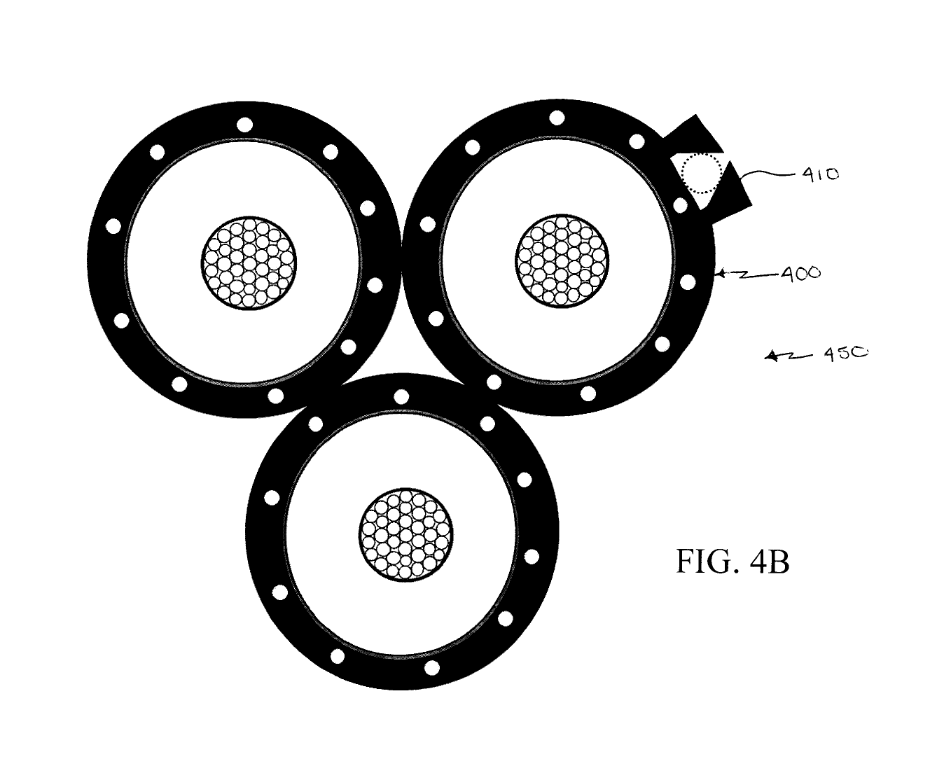

FIG. 4A illustrates a fourth exemplary embodiment of a power cable 400 of the present invention. The power cable 400 includes first and second shaped extensions 440 extending from an outer surface 406 of the cable's jacket 404. The shaped extensions 440 preferably extend longitudinally along the length of the cable and form a longitudinal channel 442 therebetween that is configured to receive the microduct 410. The shaped extensions 440 are preferably integral with the cable jacket 404; however, they can be formed separately and attached to the outer surface 406 of the jacket 404. The channel 442 provides protection to the microduct 410 and can support the microduct 410 without a bonding agent, such as adhesive. Between the radial ends of the shaped extensions 440 there is a longitudinal gap 444 such that the channel 442 is not entirely enclosed. Preferably the gap 444 between the shaped ends 440 is less than 50% of the outer diameter of the microduct 410. Alternatively, the radial ends of the shaped extensions 440 may be configured to contact one another, thereby completely enclosing the channel 442. The shaped extensions 440 preferably have a generally triangular cross-sectional shape, as seen in FIG. 4A; however, the shaped extensions 440 may have any shape as long as the channel 442 therebetween can accommodate the microduct 410.

As seen in FIG. 4B, the power cable 400 may also be incorporated into a power cable assembly 450, as seen in FIG. 4B. Like the power cable assemblies 150, 250, and 350, the power cable assembly 450 includes a plurality of cables where at least one of the cables is the power cable 400 having the microduct 310. The power cable assembly 450 may include multiple cables having a microduct like microduct 410 of the power cable 400. And the power cable assembly 450 may include any number of power cables.

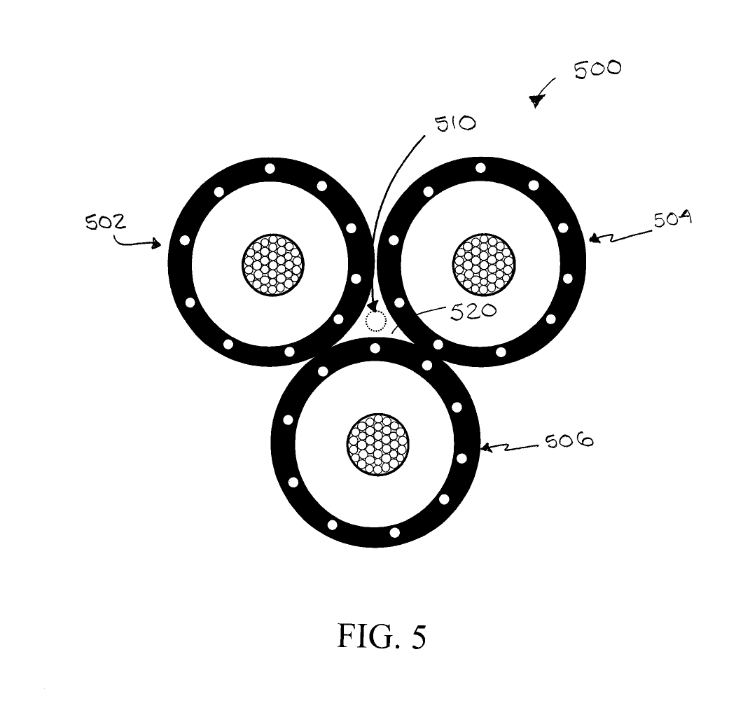

FIG. 5 illustrates a fifth exemplary embodiment of the present invention of a power cable assembly 500 that may include multiple power cables arranged to support a microduct 510 therebetween. More specifically, first, second, and third cables 502, 504 and 506 are arranged together in an assembly defining a central longitudinal axis and a longitudinal area 520 therebetween configured to receive the microduct 510. The microduct 510 generally extends along the central longitudinal axis of the cable assembly. Although the power cable assembly 500 is shown with three cables, the assembly 500 may include any number of cables as long as the longitudinal area accommodates the microduct 510.

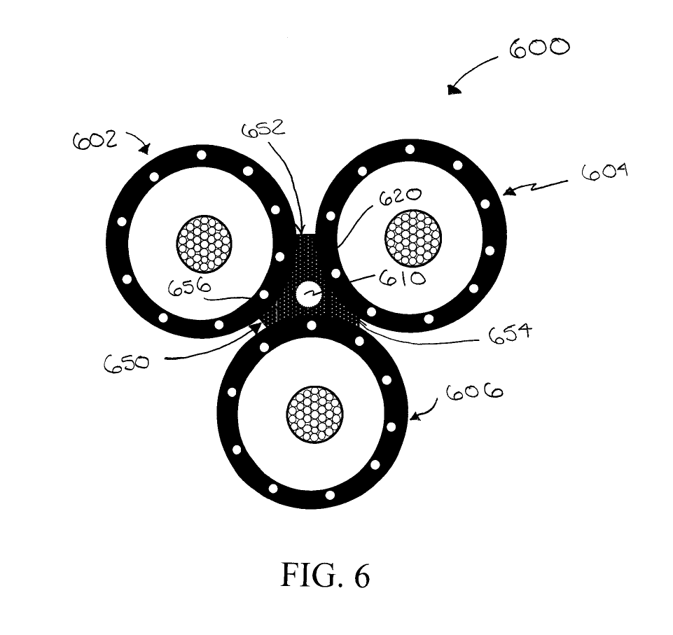

FIG. 6 illustrates a sixth exemplary embodiment of the present invention of a power cable assembly 600 similar to the power cable assembly 500 of the fifth embodiment, except that a foam portion 650 is provided in the longitudinal area 620 between the first, second, and third power cables 602, 604 and 606. The foam portion 650 may have first, second and third arms 652, 654, and 656 extending to first, second, and third cables 602, 604, and 606, respectively. The foam portion 650 provides additional protection, e.g. crush resistance, to the microduct 610 between the cables. The foam material of the foam portion 650 preferably has a low thermal resistivity, such as foam containing thermally conductive ceramic particles or graphite.

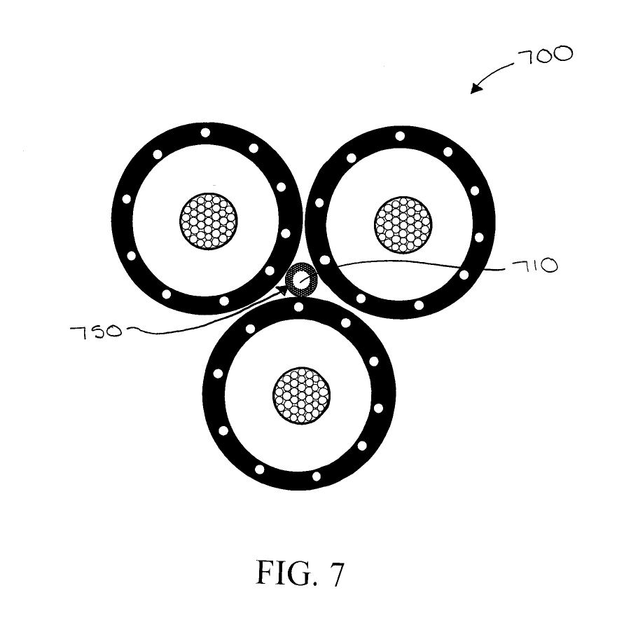

FIG. 7 illustrates a seventh exemplary embodiment of the present invention of a power cable assembly 700 similar to the power cable assemblies 500 and 600, except that the foam portion 750 is wrapped around the microduct 710 like a longitudinal tape sealed around the microduct 710. The foam portion 750 provides support and crush resistance to the microduct 710.

While particular embodiments have been chosen to illustrate the invention, it will be understood by those skilled in the art that various changes and modifications can be made therein without departing from the scope of the invention as defined in the appended claims.

What is claimed is:

1. A power cable, comprising:
a cable core having at least one power conductor, said cable core defining a longitudinal axis of the cable;
a jacket surrounding said cable core, said jacket having an outer surface; and
a longitudinal duct coupled to said outer surface of said jacket and extending substantially parallel to said longitudinal axis of said cable core, said longitudinal duct being hollow to receive at least one optical fiber.

2. A power cable according to claim 1, wherein
a web extends between said outer surface of said jacket and said longitudinal duct.

3. A power cable according to claim 2, wherein
an outer diameter of said longitudinal duct being substantially smaller than an outer diameter of said jacket.

4. A power cable according to claim 1, wherein
said outer surface of said jacket includes a longitudinal recess for receiving said longitudinal duct.

5. A power cable according to claim 4, wherein
first and second longitudinal ribs extend from said outer surface of said jacket at said longitudinal recess.

6. A power cable according to claim 4, wherein
said longitudinal duct is coupled to said outer surface of said jacket by adhesive.

7. A power cable according to claim 1, wherein
said longitudinal duct is at least partially embedded in said outer surface of said jacket.

8. A power cable according to claim 1, wherein
first and second shaped extensions extend from said outer surface of said jacket, said first and second shaped extensions forming a recess for receiving said longitudinal duct.

9. A power cable, comprising:
a cable core having at least one power conductor, said cable core defining a longitudinal axis of the cable;
a jacket surrounding said cable core;
a longitudinal duct co-extruded with said jacket such that said duct is substantially parallel to said longitudinal axis of said cable core; and
a web extending between said jacket and said longitudinal duct, said longitudinal duct being configured to receive optical fiber.

10. A power cable according to claim 9, wherein
said jacket and said longitudinal duct are formed of a polymeric material, said polymeric material is formed from a thermoset polymer or a thermoplastic polymer.

11. A power cable according to claim 10, wherein
said thermoset polymer or said thermoplastic polymer is one of a thermoset crosslinked polyethylene, a thermoset chlorinated polyethylene, a thermoplastic chlorinated polyethylene, a thermoplastic linear low density polyethylene, a thermoplastic low density polyethylene, a thermoplastic medium density polyethylene, a thermoplastic high density polyethylene, a thermoplastic polyvinyl chloride, a thermoplastic low smoke non-halogen polymer, or a thermoset low smoke non-halogen polymer.

12. A power cable according to claim 9, wherein
said jacket and said longitudinal duct are wither non-conductive or semi-conductive.

13. A power cable according to claim 9, wherein
said web is co-extruded with said jacket and said longitudinal duct.

14. A power cable according to claim 9, wherein
said outer surface of said jacket includes a longitudinal recess for receiving said longitudinal duct.

15. A power cable according to claim 14, wherein
first and second longitudinal ribs extend from said outer surface of said jacket at said longitudinal recess.

16. A power cable according to claim 14, wherein
said longitudinal duct is coupled to said outer surface of said jacket by adhesive.

17. A power cable according to claim 9, wherein
said longitudinal duct is at least partially embedded in said outer surface of said jacket.

18. A power cable according to claim 9, wherein
first and second shaped extensions extend from said outer surface of said jacket, said first and second shaped extensions forming a recess for receiving said longitudinal duct.

19. A power cable, comprising:
a cable core having at least one power conductor, said cable core defining a longitudinal axis of the cable;
a jacket surrounding said cable core, said jacket having an outer surface that defines an outer diameter of said jacket; and
a longitudinal duct coupled to said outer surface of said jacket such that said duct is substantially parallel to said longitudinal axis of cable core, said longitudinal duct having an outer diameter, said outer diameter of said duct being substantially smaller than said outer diameter of said jacket, wherein said longitudinal duct is hollow to receive optical fiber.

20. A power cable according to claim 19, wherein
a web extends between said outer surface of said jacket and said longitudinal duct.

21. A power cable according to claim 19, wherein
said outer surface of said jacket includes a longitudinal recess for receiving said longitudinal duct.

22. A power cable according to claim 21, wherein
first and second longitudinal ribs extend from said outer surface of said jacket at said longitudinal recess.

23. A power cable according to claim 19, wherein
said longitudinal duct is at least partially embedded in said outer surface of said jacket.

24. A power cable according to claim 19, wherein
first and second shaped extensions extend from said outer surface of said jacket, said first and second shaped extensions forming a recess for receiving said longitudinal duct.

25. A power cable assembly, comprising:
a plurality of cables, at least one cable of said plurality of cables including
a cable core having at least one power conductor, said cable core defining a longitudinal axis of the cable;
a jacket surrounding said cable core, said jacket having an outer surface; and
a longitudinal duct coupled to said outer surface of said jacket and extending substantially parallel to said longitudinal axis of said cable core, said longitudinal duct being hollow to receive at least one optical fiber.

26. A power cable assembly according to claim 25, wherein
a web extends between said outer surface of said jacket and said longitudinal duct of said at least one cable.

27. A power cable assembly according to claim 26, wherein
an outer diameter of said longitudinal duct being substantially smaller than an outer diameter of said jacket.

28. A power cable assembly according to claim 25, wherein
said outer surface of said jacket of said at least one cable includes a longitudinal recess for receiving said longitudinal duct.

29. A power cable assembly according to claim 28, wherein
first and second longitudinal ribs extend from said outer surface of said jacket at said longitudinal recess.

30. A power cable assembly according to claim 28, wherein
said longitudinal duct is coupled to said outer surface of said jacket by adhesive.

31. A power cable assembly according to claim 25, wherein
said longitudinal duct of said at least one cable is at least partially embedded in said outer surface of said jacket.

32. A power cable assembly according to claim 25, wherein
first and second shaped extensions extend from said outer surface of said jacket of said at least one cable, said first and second shaped extensions forming a recess for receiving said longitudinal duct.

33. A power cable assembly according to claim 25, wherein
said longitudinal duct is co-extruded with said jacket such that said duct is substantially parallel to a longitudinal axis of said cable core of said at least one cable.

34. A power cable assembly according to claim 25, wherein
said longitudinal duct of said at least one cable has an outer diameter, said outer diameter is substantially smaller than said outer diameter of said jacket of said at least one cable.

35. A power cable assembly, comprising:
at least a first cable having a cable core with at least one power conductor, and a first jacket surrounding said cable core; and
at least a second cable having a cable core with at least one power conductor, and a second jacket surrounding said cable core of said second cable, said first and second cables being arranged to form a longitudinal receiving area therebetween; and
a longitudinal duct being received in said longitudinal receiving area.

36. A power cable assembly according to claim 35, wherein
said longitudinal duct is hollow to receive at least one optical fiber.

37. A power cable assembly according to claim 35, further comprising
a third cable having a cable core with at least one power conductor, and a third jacket surrounding said cable core of said third cable, said third cable being arranged with said first and second cables to form said longitudinal receiving area.

38. A power cable assembly according to claim 35, wherein
a foam portion connects said first and second cable jackets in said longitudinal receiving area.

39. A power cable assembly according to claim 38, wherein
said longitudinal duct is encased in said foam portion.

40. A method for making a power cable, comprising the steps of:
extruding a power cable that has a cable core with at least one power conductor and a jacket that surrounds the cable core; and
co-extruding a hollow longitudinal duct with the extrusion of the power cable such that the longitudinal duct is coupled to an outer surface of the jacket and an outer diameter of the longitudinal duct is substantially smaller than an outer diameter of the jacket of the power cable.

41. A method according to claim 40, further comprising the step of:
installing optical fiber into the hollow longitudinal duct.

42. A method according to claim 41, wherein
the optical fiber is blown into the hollow longitudinal duct.
